(19) United States
(12) Patent Application Publication
(10) Pub. No.: US 2009/0095007 A1
(43) Pub. Date: Apr. 16, 2009

(54) INDOOR UNIT OF AIR CONDITIONER, COVER MEMBER THEREOF, AND METHOD FOR EMBEDDING INDOOR UNIT IN WALL

(75) Inventors: Hiroshi Ohmae, Shiga (JP); Toshihiro Kizawa, Shiga (JP); Hisashi Shimizu, Osaka (JP); Kenjirou Suzuki, Shiga (JP)

Correspondence Address: GLOBAL IP COUNSELORS, LLP, 1233 20TH STREET, NW, SUITE 700, WASHINGTON, DC, 20036-2680, US

(73) Assignee: Daikin Industries, Ltd., Osaka (JP)

(21) Appl. No.: 12/159,803

(22) PCT Filed: Dec. 25, 2006
(86) PCT No.: PCT/JP2006/325729

§ 371 Date: Jul. 1, 2008

(30) Foreign Application Priority Data
Jan. 4, 2006 (JP) 2006-000152

(51) Int. Cl. F25D 23/00; B23P 19/04

(52) U.S. Cl. 62/259.1; 29/700

(57) ABSTRACT

The indoor unit comprises a body and a cover member. The body has a rear ledge. The rear ledge can be embedded in a wall. The cover member has a plurality of cover elements. The plurality of cover elements is aligned along the direction in which the rear ledge is embedded in a wall. The plurality of cover elements can be partitioned. The cover member covers at least part of the rear ledge.

### TECHNICAL FIELD

The present invention relates to an indoor unit of an air conditioner, to a cover member thereof, and to a method for embedding the indoor unit in a wall.

### BACKGROUND ART

Conventional indoor units of floor model air conditioners include indoor units that can be installed embedded in a wall, such as is disclosed in Patent Document 1. This indoor unit has in a body casing a rear embedded portion that is embedded in a wall. In cases in which the indoor unit is not embedded in a wall, the embedded portion is covered by a cover. The cover is a U-shaped member in order to cover the top and both sides of the embedded portion.

<Patent Document 1>

Japanese Patent Laid-open Application No. 10-300186

### DISCLOSURE OF THE INVENTION

### Problems the Invention is Intended to Solve

However, in the indoor unit disclosed in Patent Document 1, when it is not possible to embed the entire embedded portion due to a wall being thin or another reason, a decorated board or the like must be attached to the exposed portion in order to conceal the portion of the embedded portion that is exposed from the wall. Therefore, the outward appearance of the indoor unit loses aesthetic appeal.

An object of the present invention is to provide an indoor unit of an air conditioner, a cover member thereof, and a method for embedding the indoor unit in a wall, wherein the embedded portion of the body can be concealed in accordance with the embedded amount, and the indoor unit embedded in a wall can be given an attractive outward appearance.

### Means for Solving these Problems

The indoor unit of an air conditioner according to a first aspect is a floor model. The indoor unit comprises a body and a cover member. The body has a rear ledge. The rear ledge can be embedded in a wall. The cover member has a plurality of cover elements. The plurality of cover elements is aligned along the direction in which the rear ledge is embedded in the wall. The plurality of cover elements can be partitioned. The cover member covers at least part of the rear ledge.

Since the cover member for covering the rear ledge of the body has a plurality of partitionable cover elements aligned in the direction in which the rear ledge is embedded in the wall, the width of the cover member can be adjusted in stages by removing some of the plurality of cover elements in accordance with the embedded amount in which the rear ledge is embedded in the wall. Further this makes it possible to adjust the width of the cover member in stages to conceal an exposed portion with the cover member if there is an exposed portion in the rear ledge because of a thin wall or some other reasons. As a result, the embedded indoor unit has an attractive outward appearance.

The indoor unit of an air conditioner according to a second aspect is an indoor unit of an air conditioner according to the first aspect, wherein the cover member has at least one groove. The groove extends in the circumferential direction of the body. The cover member can be partitioned along the groove.

Since the cover member has the groove extending in the circumferential direction of the body, the cover member can be readily partitioned.

The indoor unit of an air conditioner according to a third aspect is an indoor unit of an air conditioner according to the first aspect, wherein the cover member has at least one self-sustaining part. The self-sustaining part extends in a circumferential direction of the body.

Since the cover member has an independent part extending in the circumferential direction of the body, the strength of the cover member can be improved. Moreover, the partitioning of the cover member can be facilitated as a result of the independent part reinforcing the cover elements.

The indoor unit of an air conditioner according to a fourth aspect is the indoor unit of an air conditioner according to the first aspect, wherein the cover elements are detachably linked to each other.

Since the cover elements are detachably linked to each other, it is possible to conceal an exposed portion in the rear ledge by linking the cover elements, even in cases in which an indoor unit already embedded in a wall is removed and embedded in another thin wall.

A cover member according to a fifth aspect has a plurality of cover elements. The plurality of cover elements can be partitioned. The cover member covers at least part of a rear ledge embedded in a wall in a body of an indoor unit of a floor model air conditioner.

Since the cover member has a plurality of partitionable cover elements, the width of the cover member can be adjusted in stages in accordance with the embedded amount in which the rear ledge is embedded in the wall in the body of the indoor unit of a flood model air conditioner. Further this makes it possible to adjust the width of the cover member in stages to conceal an exposed portion with the cover member if there is an exposed portion in the rear ledge because of a thin wall or some other reasons. As a result, the embedded indoor unit has an attractive outward appearance.

A method for embedding an indoor unit according to a sixth aspect has a removal step and an embedding step. The removal step is a step for removing some of a plurality of partitionable cover elements in a cover member having the cover elements in accordance with the embedded amount in which a rear ledge of an indoor unit of an air conditioner is embedded in a wall. The embedding step is a step for embedding the rear ledge in a wall in a state in which the cover member is mounted.

Since the method for embedding the indoor unit has a removal step for removing some of the cover elements in accordance with the embedded amount in which the rear ledge of the body is embedded in a wall, and an embedding step for embedding the rear ledge in a wall, the width of the cover member can be adjusted in stages in accordance with the embedded amount in which the rear ledge is embedded in a wall. This makes it possible to adjust the width of the cover member in stages to conceal an exposed portion with the cover member if there is an exposed portion in the rear ledge because of a thin wall or some other reasons. As a result, the embedded indoor unit has an attractive outward appearance.

### EFFECT OF THE INVENTION

According to the first aspect, the width of the cover member can be adjusted in stages in accordance with the embedded amount in which the rear ledge of the indoor unit body is embedded in a wall. This makes it possible to adjust the width of the cover member in stages to conceal an exposed portion with the cover member if there is an exposed portion in the rear ledge because of a thin wall or some other reasons, and the embedded indoor unit can be given an attractive outward appearance.

According to the second aspect, the cover member can be readily partitioned.

According to the third aspect, the cover member can be made stronger. Moreover, the cover member can be readily partitioned.

According to the fourth aspect, the exposed portion of the rear ledge can be concealed by linking the cover elements even in cases in which an indoor unit already embedded in a wall is removed and embedded in another thin wall.

According to the fifth aspect, the width of the cover member can be adjusted in stages in accordance with the embedded amount in which the rear ledge is embedded in a wall in the body of the indoor unit of a floor model air conditioner. This makes it possible to adjust the width of the cover member in stages to conceal an exposed portion with the cover member if there is an exposed portion in the rear ledge because of a thin wall or some other reasons, and the embedded indoor unit can be given an attractive outward appearance.

According to the sixth aspect, the width of the cover member can be adjusted in stages in accordance with the embedded amount in which the rear ledge of the indoor unit body is embedded in a wall. This makes it possible to adjust the width of the cover member in stages to conceal an exposed portion with the cover member if there is an exposed portion in the rear ledge because of a thin wall or some other reasons, and the embedded indoor unit can be given an attractive outward appearance.

### BRIEF DESCRIPTION OF THE DRAWINGS

FIG. 1 is a front view of the indoor unit of an air conditioner according to an embodiment of the present invention.

FIG. 2 is a side view of the indoor unit in FIG. 1.

FIG. 3 is a perspective view of the cover member of the indoor unit in FIG. 1 in a removed state.

FIG. 4 is a longitudinal cross-sectional view of the indoor unit in FIG. 1.

FIG. 5 is an enlarged cross-sectional view of the vicinity of the cover member in the indoor unit in FIG. 4.

### DESCRIPTION OF THE REFERENCE SYMBOLS

1 Air conditioner
2 Body
3 Indoor heat exchanger
4 Fan
5 Shutter
6 Stepper motor
7 Filter
8 Front grill
9 Cover member
10 Front panel
24 Top discharge port
25 Bottom discharge port
27 Top space
28 Bottom space
51 Rear ledge
54 Groove
55, 56, 57, 58 Cover elements
59 Rib

### BEST MODE FOR CARRYING OUT THE INVENTION

The following is a description, made with reference to the drawings, of an indoor unit of an air conditioner, a cover member thereof, and a method for embedding the indoor unit in a wall, according to an embodiment of the present invention.

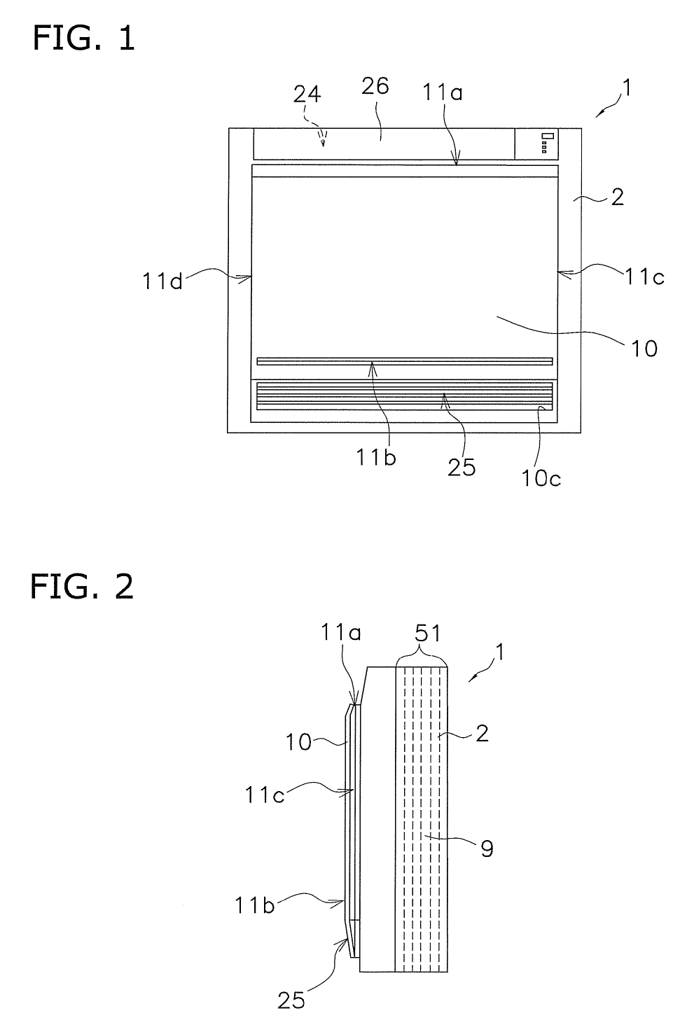

An indoor unit 1 of an air conditioner shown in FIGS. 1 through 5 is a floor model indoor unit, and comprises a body 2, an indoor heat exchanger 3, a fan 4, a shutter 5, a stepper motor 6, a filter 7, a front grill 8, a cover member 9, and a front panel 10. The front panel 10 disposed on the front surface of the body 2 has a flat (plane) shape.

The indoor heat exchanger 3, the fan 4, the shutter 5, the stepper motor 6, the filter 7, and the front grill 8 are housed within the body 2.

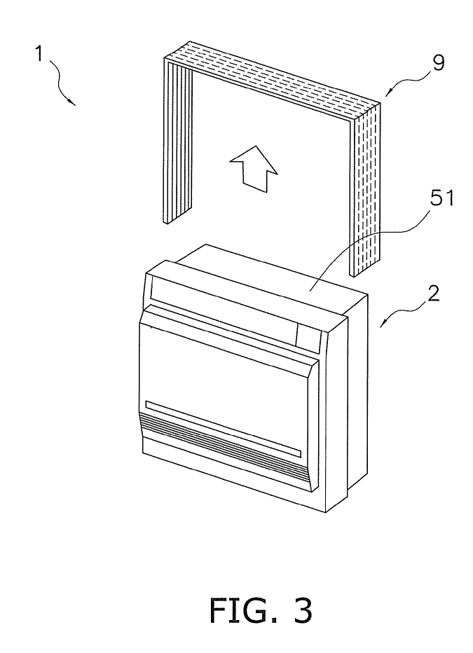

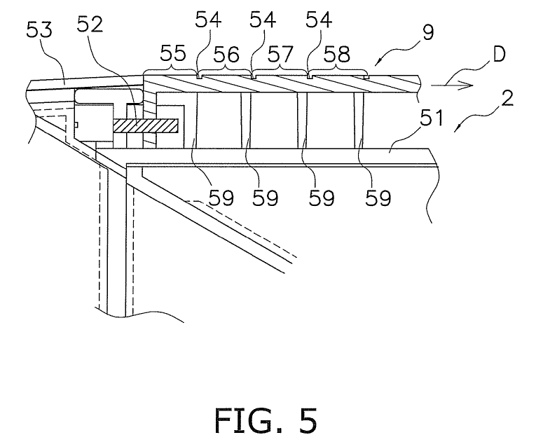

The indoor unit 1 is used while resting on the floor of a room. Not only can the indoor unit 1 be installed so that the body 2 is in contact with the surface of the wall of the room, but the indoor unit 1 can also be installed in a state in which all or part of the cover member 9 (described hereunder) is removed as shown in FIGS. 3 and 5, whereby all or part of a rear ledge 51 of the body 2 is embedded in the wall of the room.

<Configuration of Body 2>

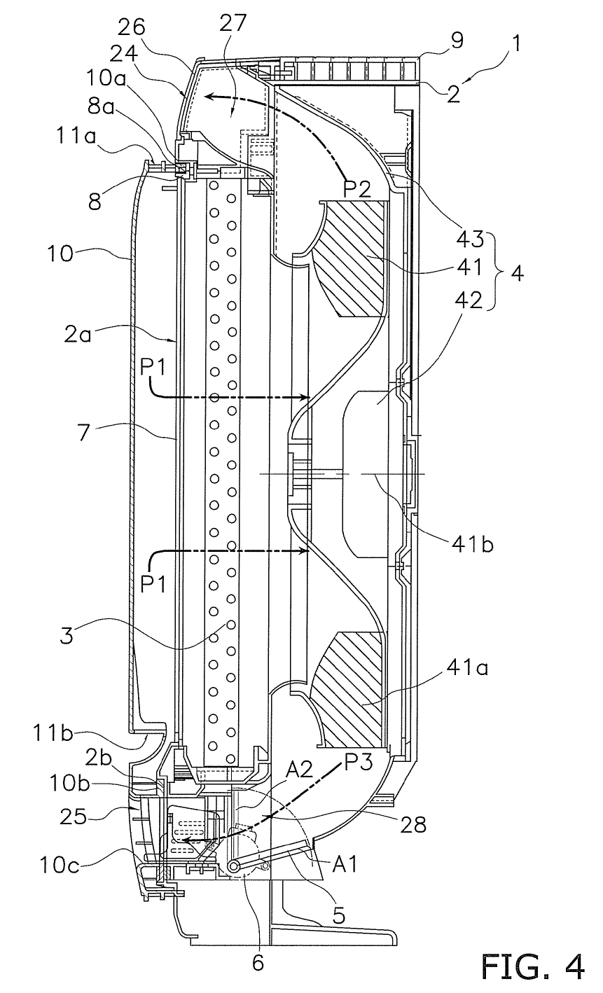

The body 2 is composed of a hollow casing made of a synthetic resin, as shown in FIGS. 4 and 5.

The rear ledge 51 of the body 2, which can be embedded in a wall, is formed so as to be lower than a front top surface 53, as shown in FIG. 5. The height of the cover member 9 for covering the rear ledge 51 is set so as to be equal to the height of the front top surface 53.

In the interior of the body 2, the filter 7, the indoor heat exchanger 3, and the fan 4 are placed in the stated order backward from a front opening 2a formed in the front surface, as shown in FIG. 4.

The front grill 8 is mounted in the peripheral edge of the front opening 2a of the body 2. The filter 7 is fitted into the front grill 8.

The flat front panel 10 is disposed in front of the front opening 2a of the body 2 and is suspended from the front opening 2a.

The front panel 10 has a top intake port 11a, a bottom intake port 11b, a first side intake port 11c, and a second side intake port 11d in the top, the bottom, and the left and right sides. Specifically, the front panel 10 is disposed frontward of and set apart from the body 2, thereby forming three ports of the top intake port 11a, the first side intake port 11c, and the second side intake port 11d (see FIG. 1) on three sides, namely, the top, left, and right, of the front panel 10. The slit-shaped bottom intake port 11b is formed at a position at the bottom of the front panel 10 and slightly higher than a bottom discharge port 25. The intake ports 11a, 11b, 11c, and 11d are thereby disposed respectively at the top, bottom, left, and right sides of the front panel 10.

Fitting protrusions 10a, 10b are formed respectively in the top and bottom of the front panel 10. The fitting protrusions 10a, 10b are fitted respectively in a fitting concavity 8a of the front grill 8 and a fitting hole 2b in the vicinity of the front bottom end of the body 2, whereby the front panel 10 is fixed in a state of being suspended from the front opening 2a of the body 2.

An intake duct P1, a top discharge duct P2, and a bottom discharge duct P3 are formed in the body 2.

The intake duct P1 is a duct that passes through any of the four intake ducts of the front panel 10, namely, the top intake port 11a, the bottom intake port 11b, the first side intake port 11c, and the second side intake port 11d; then enters the body 2 through the front opening 2a, and passes through the filter 7, the indoor heat exchanger 3, and the fan 4 in the stated order.

The top discharge duct P2 is a duct that runs from the fan 4 through a top space 27 to a top discharge port 24. The top discharge port 24 is formed above the front opening 2a of the body 2. A movable plate 26 capable of opening and closing is placed over the top discharge port 24.

The bottom discharge duct P3 is a duct that runs from the fan 4 through a bottom space 28 to the bottom discharge port 25. The bottom discharge port 25 is formed below the front opening 2a of the body 2. The shutter 5, which is capable of opening and closing, is placed over the bottom space 28. Furthermore, a stopper 37 that is in contact with the shutter 5 in a closed state is formed inside the bottom space 28. A plurality of slits 10c that extends horizontally is formed in a portion of the front panel 10 in front of the bottom discharge port 25.

<Configuration of Fan 4>

The fan 4 is a turbofan, which is a type of centrifugal fan that blows air out in the centrifugal direction, and comprises a fan rotor 41, a motor 42, and a fan casing 43, as shown in FIG. 4. The fan rotor 41 has a plurality of blades 41a (the diagonal line portions in FIG. 4) disposed so as to extend away from a center 41b in a helical formation.

The fan casing 43 is a casing that houses the fan rotor 41 and the motor 42. The top of the fan casing 43 communicates with the top space 27 of the body 2. The bottom of the fan casing 43 communicates with the bottom space 28 of the body 2.

The air flow which is created by the fan 4 and blown out in the centrifugal direction diverges up and down from the fan casing 43 and passes respectively through the top discharge duct P2 and the bottom discharge duct P3, and is then discharged to the outside of the body 2 respectively from the top discharge port 24 and the bottom discharge port 25.

<Configuration of Cover Member 9>

The cover member 9 has a plurality of dividable cover elements 55, 56, 57, 58, as shown in FIGS. 3 through 5. The cover elements 55, 56, 57, 58 are aligned along the direction D in which the rear ledge 51 is embedded in the wall. The cover member 9 is manufactured from a synthetic resin so that the cover elements 55, 56, 57, 58 are integrated.

The cover member 9 is a member that covers at least part of the rear ledge 51 of the body 2, and is formed in the shape of a U in order to cover the top and both sides of the rear ledge 51. The cover member 9 is fixed to the body 2 by screws 52. The cover member 9 shown in FIGS. 2 through 5 covers the entire rear ledge 51 of the body 2.

The width of the cover member 9 can be adjusted in stages in accordance with the embedded amount in which the rear ledge 51 of the body 2 is embedded within the wall, by partitioning one or more of the plurality of the cover elements 55, 56, 57, 58 of the cover member 9.

The cover member 9 also has grooves 54 which extend in the circumferential direction of the body 2 in the external peripheral surface of the cover member 9. The grooves 54 are formed in the vicinity of the borders of the plurality of the cover elements 55, 56, 57, 58. The cover member 9 is thereby designed so that one or more of the cover elements 55, 56, 57, 58 of the cover member 9 can be partitioned along the grooves 54.

The grooves 54 are formed by being molded at the same time that the cover member 9 is manufactured from a synthetic resin, by being cut after the cover member 9 is molded, or by another such method.

Furthermore, the cover member 9 has ribs 59 as independent parts extending in the circumferential direction of the body 2. The ribs 59 are formed respectively on the cover elements 55, 56, 57. The strength of the cover member 9 can be improved by these ribs 59.

The ribs 59 are disposed so as to be offset from the grooves 54 in the front-to-back direction of the rear ledge 51 of the body 2; therefore, when the cover elements 55, 56, 57, 58 are partitioned along the grooves 54, the cracking created from the grooves 54 does not interfere with the ribs 59. Moreover, since the ribs 59 reinforce the cover elements 55, 56, 57 respectively at a position nearest to the grooves 54, the cover elements 55, 56, 57 can be prevented from deforming when partitioned. The cover elements 55, 56, 57, 58 can thereby be readily partitioned along the grooves 54.

<Method for Embedding Indoor Unit 1 in Wall>

In cases in which the indoor unit 1 is embedded in a wall, some of the cover elements 55, 56, 57, 58 are first removed in accordance with the embedded amount in which the rear ledge 51 of the body 2 of the indoor unit 1 is embedded in the wall (removal step).

When the cover member 9 is partitioned, the cover member 9 may be removed from the body 2 and partitioned, or the cover member 9 may be partitioned while still mounted on the body 2.

Next, the rear ledge 51 is embedded in the wall in a state in which the cover member 9 is mounted (embedding step).

According to this embedding method, the width of the cover member 9 can be adjusted in stages in accordance with the embedded amount in which the rear ledge 51 of the body 2 is embedded in the wall.

<Characteristics>

(1)

In the indoor unit 1 of the embodiment, since the cover member 9 for covering the rear ledge 51 of the body 2 has a plurality of the partitionable cover elements 55, 56, 57, 58 aligned along the direction D in which the rear ledge 51 is embedded in the wall, the width of the cover member 9 can be adjusted in stages by removing some of the plurality of the cover elements 55, 56, 57, 58 in accordance with the embedded amount in which the rear ledge 51 is embedded in the wall. This makes it possible to adjust the width of the cover member 9 in stages to conceal an exposed portion with the cover member if there is an exposed portion in the rear ledge 51 because of a thin wall or some other reasons. As a result, the embedded indoor unit 1 has an attractive outward appearance.

In cases in which the exposed portion cannot be completely concealed by the cover member, the exposed portion can be coated and masked with a caulking agent for a pleasant finish, because the exposed portion is smaller than in a conventional indoor unit.

(2)

In this embodiment, the cover member 9 can be readily partitioned because the cover member 9 has at least one groove 54 extending in the circumferential direction of the body 2, and the cover member 9 can be partitioned along the grooves 54.

Since at least one groove 54 is formed in the external side of the cover member 9, a visual effect can be achieved in which the entire indoor unit 1 appears to be shallow.

(3)

In the embodiment, the strength of the cover member 9 is improved because the cover member 9 has at least one rib 59 extending in the circumferential direction of the body 2. Moreover, the partitioning of the cover member 9 can be made easier as a result of the ribs 59 reinforcing the cover elements 55, 56, 57.

(4)

The method for embedding the indoor unit 1 in a wall in the embodiment has a removal step in which some of the cover elements 55, 56, 57, 58 in the cover member 9 having a plurality of partitionable cover elements 55, 56, 57, 58 are removed in accordance with the embedded amount in which the rear ledge 51 of the body 2 is embedded in a wall, and an embedding step in which the rear ledge 51 is embedded in a wall in a state in which the cover member 9 is mounted. Therefore, the width of the cover member 9 can be adjusted in stages in accordance with the embedded amount in which the rear ledge 51 is embedded in a wall. This makes it possible to adjust the width of the cover member 9 in stages to conceal an exposed portion with the cover member if there is an exposed portion in the rear ledge 51 because of a thin wall or some other reasons. As a result, the embedded indoor unit 1 has an attractive outward appearance.

<Modification>

(A)

In the embodiment described above, the cover member 9 is manufactured from a synthetic resin so that the cover elements 55, 56, 57, 58 are integrated, but the present invention is not limited to this option alone. Another option is to manufacture cover elements 55, 56, 57, 58 that can be detachably linked to each other as separate components. In this case, the cover member 9 is configured by linking the cover elements 55, 56, 57, 58 together.

In this modification, the linking portions of the cover elements 55, 56, 57, 58 are composed of, e.g., a combination of fitting concavities and fitting convexities provided on each of the opposing surfaces of the mutually adjacent cover elements 55, 56, 57, 58. Another possible example of the linking portions is a configuration involving magnetic attraction; e.g., a combination of magnets and metal plates or other magnetic materials.

Thus, detachably linking the cover elements 55, 56, 57, 58 to each other makes it possible to conceal an exposed portion in the rear ledge by linking the cover elements, even in cases in which an indoor unit already embedded in a wall is removed and embedded in another thin wall.

(B)

In this embodiment, grooves 54 are formed in the external side of the cover member 9, but the present invention is not limited to this option alone; another option is to form grooves 54 in the internal side of the cover member 9 or in both the internal and outer sides of the cover member 9. The cover member 9 can be partitioned readily in this case as well.

### INDUSTRIAL APPLICABILITY

The present invention can be applied to an indoor unit of an air conditioner that can be embedded in a wall, to a cover member thereof, and to a method for embedding an indoor unit.

1. An indoor unit of a floor model air conditioner, comprising:
a body having a rear ledge being configured to be embedded in a wall; and
a cover member having a plurality of partitionable cover elements aligned along a direction in which the rear ledge is configured to be embedded in the wall, and the cover member covering at least part of the rear ledge.

2. The indoor unit as recited in claim 1, wherein
the cover member has at least one groove extending in a circumferential direction of the body, and
the cover member is configured to be partitioned along the groove.

3. The indoor unit as recited in claim 1, wherein
the cover member has at least one self-sustaining part extending in a circumferential direction of the body.

4. The indoor unit as recited in claim 1, wherein
the cover elements are detachably linked to each other.

5. A cover member, comprising:
a plurality of partitionable cover elements covering at least part of a rear ledge embedded in a wall in a body of an indoor unit of a floor model air conditioner.

6. A method for embedding an indoor unit, comprising:
removing some of a plurality of partitionable cover elements in a cover member having the cover elements in accordance with the embedded amount in which a rear ledge of an indoor unit of an air conditioner is embedded in a wall; and
embedding the rear ledge in the wall in a state in which the cover member is mounted.
